(19) United States
(12) Patent Application Publication
(10) Pub. No.: US 2024/0104646 A1
(43) Pub. Date: Mar. 28, 2024

(54) SYSTEM AND METHOD FOR ADVANCED CREDIT LINE INCREASE

(71) Applicant: Capital One Services, LLC, McLean, VA (US)

(72) Inventors: Abdelkader M'Hamed BENKREIRA, Washington, DC (US); Leeyat Bracha TESSLER, Arlington, VA (US); Shabnam KOUSHA, Washington, DC (US)

(73) Assignee: Capital One Services, LLC, McLean, VA (US)

(21) Appl. No.: 17/951,608

(22) Filed: Sep. 23, 2022

(51) Int. Cl. G06Q 40/02; G06Q 10/08

(52) U.S. Cl. CPC G06Q 40/025; G06Q 10/0837

(57) ABSTRACT

A system and method for providing a temporary credit line increase to a customer awaiting or expecting a refund or replenishment of funds is disclosed. The process can be initiated by a creditor or at the request of a customer. In the latter scenario, the customer provides evidence of the expected refund in the form of a shipping label, return receipt, or other communication. In some cases, additional shipping information is acquired from a shipping company associated with the shipping label. Based on the information received from the customer as well as customer account information, a temporary credit line increase amount is calculated. The customer is then informed of the temporary credit line increase and any terminating conditions. The temporary credit line increase remains available to the customer until one of the terminating conditions has been satisfied.

### TECHNICAL FIELD

Embodiments of the present disclosure are related to merchant transactions, and specifically to e.g., providing a credit line increase in anticipation of an expected refund prior to receipt.

### BACKGROUND

Most consumers have limited spending capacity, either because they lack excess income or because they have limited credit available to them. As a result, if a consumer is near or at their spending limit, the purchasing capacity is greatly reduced. And if a transaction that is either in error or requested for reversal pushes up to or over the spending limit, the consumer may be in spending limbo until the transaction is cleared from their records.

### BRIEF DESCRIPTION OF THE DRAWINGS/FIGURES

The accompanying drawings are incorporated herein and form a part of the specification.

FIG. 1 illustrates a block diagram of exemplary advanced crediting environment according to various embodiments.

FIG. 2 illustrates a block diagram of an exemplary advanced crediting system according to various embodiments.

FIG. 3 illustrates a flowchart diagram of an exemplary method for providing an advanced credit line increase according to various embodiments.

FIG. 4 illustrates a flowchart diagram of an exemplary method for providing an advanced credit line increase according to various embodiments.

FIG. 5 illustrates a flowchart diagram of an exemplary method for terminating an advanced credit line increase according to various embodiments.

FIG. 6 illustrates an exemplary computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for providing a temporary line of credit, e.g., a credit line increase, in anticipation of a refund, reimbursement, or other replenishment of the main credit line.

Most consumers have limited spending capacity, either because they lack excess income or because they have limited credit available to them. As a result, if a consumer is near or at their spending limit, the purchasing capacity is greatly reduced. This effect is particularly frustrating to the customer while they await return funds to become available.

In one example, when a customer makes a return, the cost of the goods being returned is credited back to their account, and their available credit is increased accordingly. However, there can be substantial time duration between the return of the goods and the availability of the credit. For example, there may be a delay due to shipping (e.g., many online retailers will not issue a refund until the item is either shipped or received) or due to posting time (e.g., there is delay between a refund being received by the credit card company and the credit being posted to the user's account). Therefore, according to the present disclosure, a method and system for providing an advanced and temporary credit line increase is disclosed.

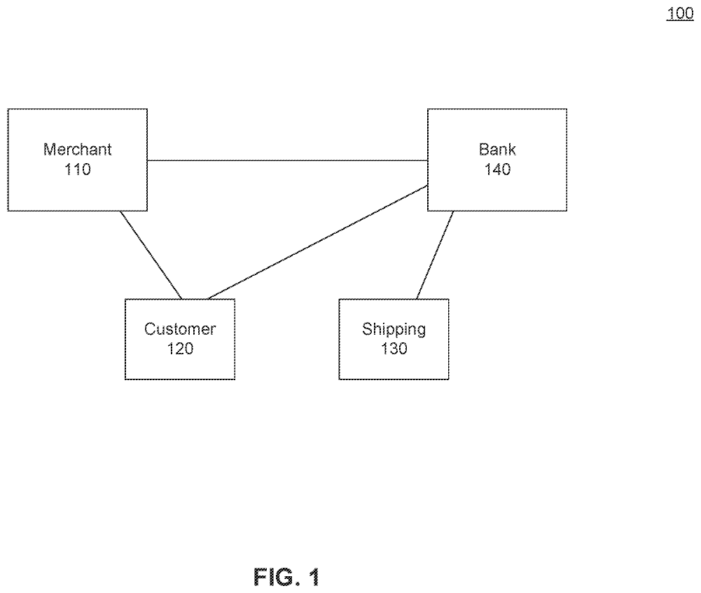

FIG. 1 illustrates a block diagram of exemplary advanced crediting environment 100 according to various embodiments. In one example, environment 100 comprises a merchant 110, a customer 120, a shipping entity 130, and a bank 140.

In an embodiment, the merchant 110 is the point-of-sale for the customer 120. In other words, the customer 120 purchased goods or services from the merchant 110 either in person or online using credit provided to the customer 120 by the bank 140. At some point thereafter, a refund of funds is authorized by the merchant 110 to the 120. According to various embodiments, the refund may be issued for a variety of different reasons, such as in response to the customer returning goods, the customer being overcharged, the customer being mistakenly charged, a negotiation of price, or any other reason for reimbursing the customer.

In an embodiment, when a refund is authorized by the merchant 110, the refund is sent to the bank 140. In embodiments, the bank 140 may be any financial institution capable of providing credit to a customer, such as a bank, credit card company, investment firm, credit union, mortgage company, etc. As is typical when a refund is issued, the bank 140 begins processing the refund, which can take several days.

In embodiments, if the customer so desires, the customer 120 can request a temporary credit line increase in advance of the refund posting to the customer's account. The customer 120 sends the request to the bank 140. The bank 140 calculates a credit line increase amount in response to the request. In some embodiments, particularly whether the purchase was made online, the bank 140 may communicate with a shipping company 130 that has been tasked with delivering the return goods from the customer 120 to the merchant 110. These and other features will be described in further detail below with respect to the other figures.

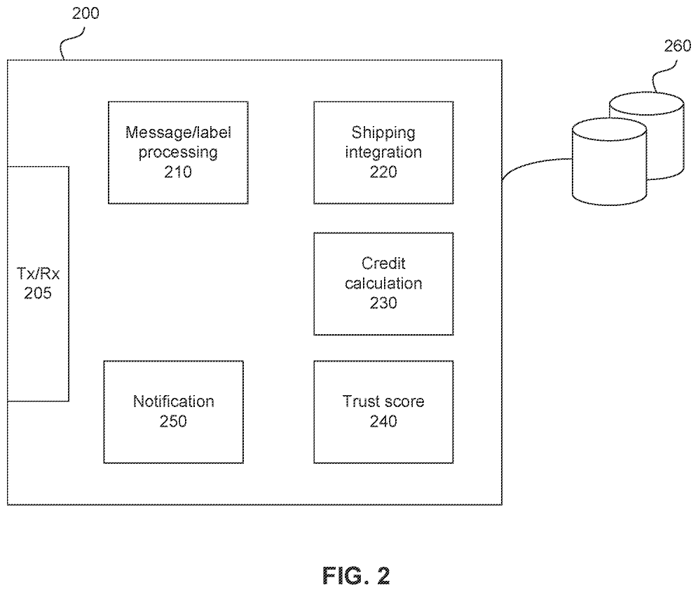

FIG. 2 illustrates a block diagram of an exemplary advanced crediting system 200 according to various embodiments. In one example, system 200 includes a transceiver 205, a message/label processing system 210, a shipping integration system 220, credit calculation system 230, a trust score system 240, notification system 250, and database 260.

In an embodiment, transceiver 205 provides for communicating with external devices, such as a server or device associated with the merchant or shipping company. The transceiver 205 receives a request message from the customer requesting a temporary credit line increase (e.g., a temporary increase in borrowing capacity) and including evidence of a pending refund or reimbursement (for ease of discussion, all manner of expected credit to the customer will be herein described as a “refund”). In an embodiment, the system 200 is a management service of a cloud server.

In an embodiment, the transceiver 205 provides the received request message to message/label processing system 210. Message/label processing system 210 is configured to review the request message for evidence of a refund. According to embodiments, the message/label processing system 210 can perform optical character recognition of an image, keyword analysis of a digital message, image analysis, etc. Through the use of these tools, the message/label processing system 210 is configured to analyze the message received from the customer and/or other information provided to the system 200 relating to the credit request, and extract information pertinent to a credit authorization decision.

In an embodiment, shipping integration system 220 is configured to communicate with a shipping company when the refund being requested involves shipped goods. For example, when an item is shipped back or returned, the customer may request temporary credit line increase for the returned item and provide, as evidence of the return, a copy of a shipping label or a shipping confirmation email. The message/label processing system 210 extracts the relevant shipping information, such as shipping company name and/or shipping barcode. The shipping integration system 220 causes the transceiver 205 to communicate with the external shipping company, and to provide the shipping company with the extracted shipping information. Shipping integration system 220 receives reply information from the shipping company that may include additional details of the shipped item, such as item weight, box size, date shipped, expected date of delivery, etc.

In an embodiment, credit calculation system 230 is configured to carry out the calculation of whether and how much temporary of a credit line increase to provide to the customer. The credit calculation system 230 receives information from the message/label processing system 210 and information from the shipping integration, as well as information from databases 260, and calculates the corresponding or appropriate amount of the credit line increase to provide to the customer. For example, in embodiments the credit calculation system 230 receives an indication from the message/label processing system 210 that a temporary credit line increase request has been initiated by a customer, a customer identifier associated with that customer, and a requested credit line increase amount. The credit calculation system 230 also receives shipping information from the shipping integration system 220, such as the weight of the return package and expected delivery date. Additionally, the credit calculation system 230 retrieves customer account data from one or more databases 260. In various embodiments, the customer account data includes one or more of a credit limit, current credit remaining, and a request history that details a number of previous temporary credit line increase requests, such as the number of requests made and the percentage of those that were satisfied (e.g., the percentage of the proposed reimbursement amounts that was actually reimbursed).

In an embodiment, the credit calculation system 230 compiles the above information and, from it, calculates a temporary credit line increase amount. In some embodiments, as part of this calculation, the credit calculation system 230 also accounts for a trust score system 240. In an embodiment, the trust score system 240 calculates a trust score associated with the customer indicative of the likelihood that the customer's refund amount will be received in full. This calculation is primarily based on the customer's request history, but can also be based on other customer data, such as credit limit and remaining credit. For example, in an embodiment, the trust score compares an expected weight of the package (based on the item being returned) to the actual weight of the package retrieved from either the shipping label or acquired from a shipping company. In other embodiments, this comparison can be performed by the credit calculation directly. When a trust score is calculated, the credit calculation system 230 uses the trust score to adjust the temporary credit line increase amount. Specifically, a low trust score reduces the calculated temporary credit line increase amount, whereas a high trust score does not (or may cause the temporary credit line increase amount to be increased).

In an embodiment, based on the above, the credit calculation system 230 calculates a temporary credit line increase amount to be applied to the customer's account. The temporary credit line increase amount will be a percentage of the expected refund amount in the range of 0%-100%, where 0% means that the request was denied and 100% means that the expected refund is fully credited. The credit calculation system 230 further calculates an expiration date of the temporary credit line increase based on the above information. In embodiments, the expiration date may be a date that the refund is expected to post to the user's account, a predetermined amount of time from the issuing of the temporary credit line increase, an expected delivery data of the shipped item, etc. Notably, termination of the temporary credit line increase can also be triggered by other events, such as the refund posting to the customer's credit account, etc.

In an embodiment, once credit calculation system 230 has determined whether and how much temporary credit line increase to give to the customer, notification system 250 generates and causes the transceiver 205 to transmit a notification message to the customer. The notification message can be any suitable means of communication including email, SMS, automated phone call, in-app notification, etc. In an embodiment, the notification message informs the customer of the grant or denial of the temporary credit line increase request. In the case of a grant notification, the notification also informs the customer of the temporary credit line increase amount and the expiration date of the temporary credit line increase.

In an embodiment, the system 200 receives a temporary credit line increase request message from the customer via transceiver 205. Message/label processing system 210 extracts information relating to the request and/or shipping label. Shipping integration system 220 communicates with an external shipping company associated with the shipping label to obtain additional information of the shipped item. This information, as well as customer account and request history data from databases 260, are provided to the credit calculation system 230. Based on this information, the credit calculation system 230 calculates how much, if any, temporary credit line increase to give to the customer. In an embodiment, trust score system 240 also calculates a trust score associated with the customer based on the customer's request and request history. The amount of temporary credit line increase calculated by the credit calculation system 230 can be adjusted based on this trust score.

In an embodiment, once the final temporary credit line increase amount has been determined, notification system 250 transmits via the transceiver 205 a notification message to the customer informing them of the decision. In the event that the credit line increase was granted, the notification message also includes the amount of the credit line increase and an expiration date and/or expiration event that will cause the temporary credit line increase to expire and be removed from the customer's account.

In an embodiment, the temporary credit line increase will remain available to the customer until the expiration trigger occurs. Once this occurs, notification system 250 transmits a termination message to the customer via transceiver 205 using any of the means described above.

It will be understood that there are a number of modifications to the above within the scope of this disclosure. For example, rather than requiring a customer to initiate the request, the system can be configured to automatically reach out to the customer or automatically issue a temporary credit line increase to the customer. Such a notification can notify the customer of the pending return and inquire as to whether they would like for a temporary credit line increase to be applied to their account, or alternatively can simply automatically add the temporary credit line increase and notify the customer as to the addition. This can occur, for example, in response to detecting a pending refund or based on some other triggering event. As an additional modification, the trust score can be calculated after the calculation of the temporary credit line increase and used to adjust the calculated amount, or can be calculated prior to calculation of the temporary credit line increase and used as part of the credit calculation.

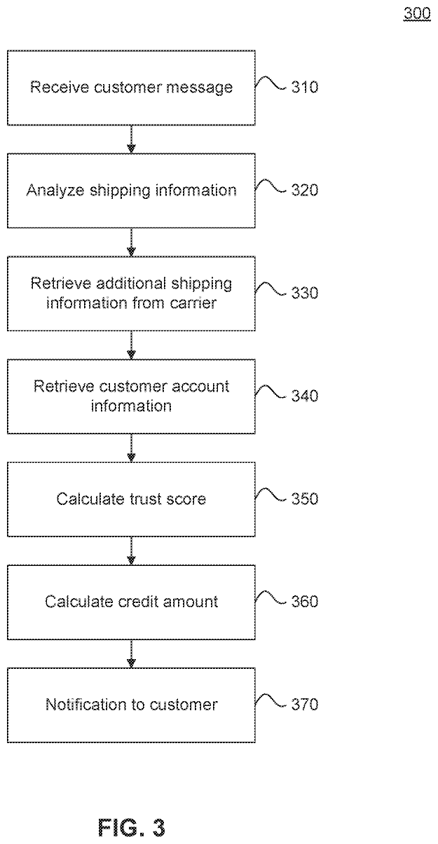

FIG. 3 illustrates a flowchart diagram of an exemplary method 300 for providing an advanced credit line increase according to various embodiments. It can be appreciated that the operations may occur in alternative orders, and some operations may not always be needed in some embodiments.

In step 310, a message is received from the customer. In the embodiment of FIG. 3, the customer request message includes evidence of the refund in the form of a shipping label or other shipping indicator.

In step 320, the shipping information is analyzed. This may include extracting a barcode, tracking number, carrier, etc. from the shipping label.

In step 330, additional shipping information is retrieved from a carrier identified in the shipping information. This additional information can include package weight, expected delivery date, package size, etc.

In step 340, customer account information is retrieved that includes a request history indicating previous temporary credit line increase requests and whether and to the amount that the refunds associated with those requests were received.

In step 350, based on the customer account information, a trust score is calculated indicative of the likelihood that the customer's refund will be received. In an embodiment, the trust score is also based on the shipping information and particularly whether there are any ambiguities or suspicions with respect to the return.

In step 360, once the trust score has been calculated, the temporary credit line increase amount is calculated based on the trust score, the customer account information, and the return information, and is a percentage of the expected refund amount. In embodiments, the calculating of the credit line increase amount can also determine whether to issue a temporary credit to the customer. Once the credit line increase amount/determination has been made, the customer is notified of the decision/amount as well as a termination condition of the temporary credit line increase.

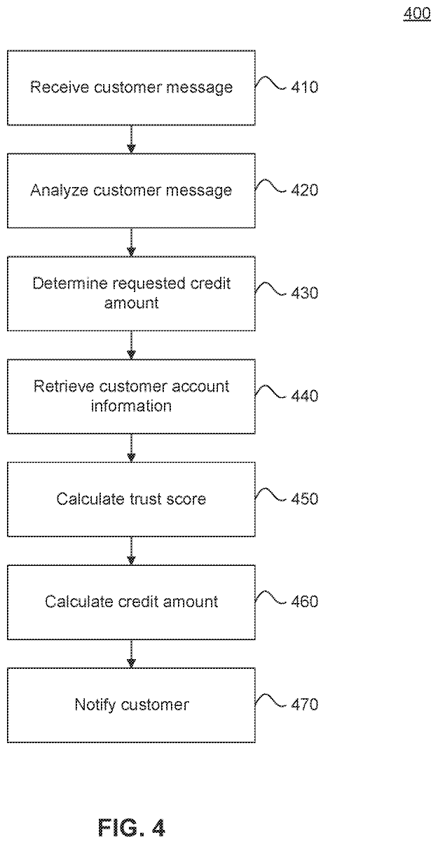

FIG. 4 illustrates a flowchart diagram of an exemplary method 400 for providing an advanced credit line increase according to various embodiments. It can be appreciated that the operations may occur in alternative orders, and some operations may not always be needed in some embodiments.

In step 410, a message is received from the customer. For example, in the embodiment of FIG. 3, the customer request message includes evidence of the refund in a variety of forms, such as an email from the merchant, image of a merchant message or other such evidence.

In step 420, the customer message is analyzed. This may include performing text analysis of the message, image analysis of any attached images, OCR of any attached images, etc. in order to identify any information that would evidence the customer being entitled to a refund or return of funds.

In step 430, a requested credit line increase amount is determined. This is the amount being requested by the customer and can be determined based on the message analysis.

In step 440, customer account information is retrieved. In embodiments, the customer account information includes at least a request history of the customer indicating the number of previous requests for temporary credit line increase that the customer has made and the number of those previous requests for which the full refund amount was received.

In step 450, based on the customer data, a trust score is calculated. The trust score provides an indication of the relative trustworthiness of the customer, and the likelihood that the refund for which they have requested temporary credit line increase will be received.

In step 460, the credit line increase amount is calculated. In an embodiment, the credit line increase amount can be as low as zero and as high as the expected return amount.

In step 470, once the credit line increase amount has been calculated, the customer is notified in. In an embodiment, the notification informs the customer as to whether the request for a temporary credit line increase was granted as well as the amount provided. Additionally, in an embodiment, the notification also informs the customer of a termination condition for the temporary credit line increase.

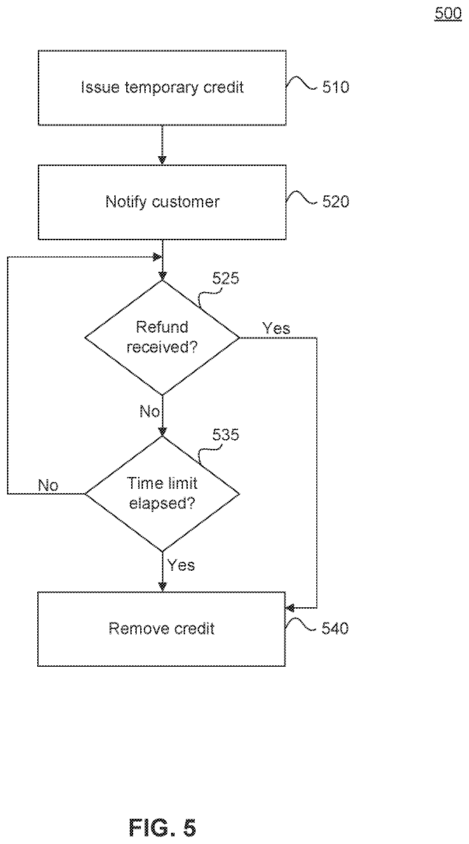

FIG. 5 illustrates a flowchart diagram of an exemplary method 500 for terminating an advanced credit line increase according to various embodiments. It can be appreciated that the operations may occur in alternative orders, and some operations may not always be needed in some embodiments.

In step 510, a temporary credit line increase is issued to the customer. For example, in the embodiment of FIG. 5, the temporary credit line increase is provided to the customer with two terminating conditions: 1) receipt of the refund for which the temporary credit line increase was requested; and 2) an elapsed time since the temporary credit line increase was issued. As discussed above, other or more terminating conditions may be appropriate.

In step 520, the customer is notified as to the granting of the temporary credit line increase as well as the terminating conditions. At this point, the terminating conditions are monitored.

In step 525, a determination is made as to whether the first terminating condition (e.g., receipt of the refund) has been satisfied.

If YES in step 525, i.e., refund has been received, method 500 moves to step 540 during which the credit line increase is removed from the customer's account.

If NO in step 525, i.e., no refund has been received, method 500 moves to step 535, where a determination is made whether a time limit has elapsed.

If YES in step 535, method 500 moves to step 540 during which the credit line increase is removed from the customer's account.

If NO in step 535, method 500 returns to step 525.

Although the method 500 is described with respect to two terminating conditions, the method 500 can be extended or shortened for any number of conditions. Each terminating condition is monitored and can trigger removal of the temporary credit line increase from the customer's account.

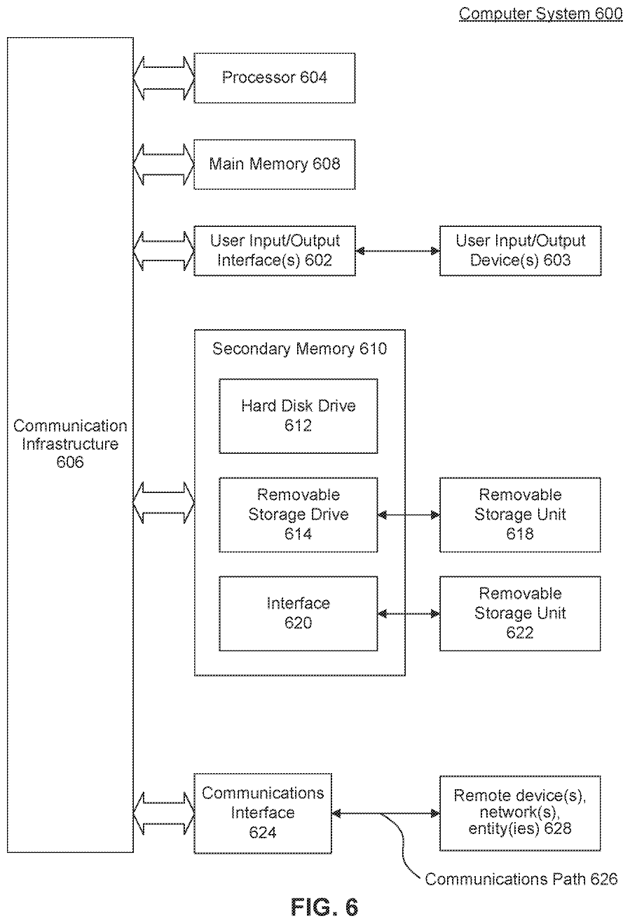

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
receiving, by a management service of a cloud server, an electronic message requesting temporary borrowing capacity for a user based on a request for borrowing capacity associated with a transaction;
receiving, by the management service of the cloud server, verifiable proof that the request for borrowing capacity has been authorized by a vendor;
retrieving, by the management service of the cloud server, data associated with the user;
approving, by the management service of the cloud server, the request for temporary borrowing capacity based on the received verifiable proof and the data;
generating, by the management service of the cloud server, an electronic control signal corresponding to an amount of the temporary borrowing capacity; and
transmitting, by the management service of the cloud server, the electronic control signal authorizing temporary borrowing capacity to the user.

2. The computer-implemented method of claim 1, wherein the receiving the verifiable proof comprises:
receiving a message from a user, the message including an indication of a pending return;
identifying a carrier from the indication;
retrieving transport information from the carrier; and
verifying the pending return based on the transport information.

3. The computer-implemented method of claim 2, wherein the indication is a return indicator.

4. The computer-implemented method of claim 2, wherein the indication is a return label.

5. The computer-implemented method of claim 2, wherein the transport information includes a package weight.

6. The computer-implemented method of claim 5, further comprising calculating the amount of the temporary borrowing capacity by comparing the package weight to an expected weight based on a product identified in the return indicator.

7. The computer-implemented method of claim 1, further comprising:
calculating a trust indicator for the user based on the user data, the trust indicator being indicative of how likely the request for borrowing capacity will be completed based on a history of the user,
wherein the temporary borrowing capacity amount is adjusted according to the trust indicator.

8. The computer-implemented method of claim 1, wherein the request for borrowing capacity is based on an incorrect amount or a mistake.

9. A system for issuing a temporary line of borrowing capacity, comprising:
a database that stores user information and a return history associated with a user;
a transceiver; and
one or more processors configured to:
cause the transceiver to receive a message from the user that includes an indication of a pending return;
cause the transceiver to retrieve transport information associated with the pending return based on the indication;
verify the pending return based on the transport information;
retrieve user data associated with the user;
calculate a temporary borrowing capacity amount based on the indication and the user data; and
provide the temporary borrowing capacity amount to the user.

10. The system of claim 9, wherein the one or more processors are further configured to identify a carrier from the indication, and
wherein the transport information is retrieved from the carrier.

11. The system of claim 9, wherein the indication is one of a return indicator or a return label.

12. The system of claim 9, wherein the transport information includes a weight.

13. The system of claim 12, wherein the one or more processors are further configured to:
determine an expected weight based on information included in the indication; and
compare the weight to the expected weight.

14. The system of claim 13, wherein the one or more processors are further configured to adjust the temporary borrowing capacity based on the comparing.

15. The system of claim 9, wherein the one or more processors are further configured to notify the user of the temporary borrowing capacity.

16. A computer-implemented method, comprising:
receiving, by a management service of a cloud server via a network, an electronic message that includes evidence of an expected refund, the evidence including an amount;
calculating, by the management service of the cloud server, a temporary borrowing capacity line based on the amount and a user history, the temporary borrowing capacity line being a percentage of the amount;
providing, by the management service of the cloud server, the temporary borrowing capacity line to the user; and
transmitting, by the management service of the cloud server via the network, a notification to the user of the temporary borrowing capacity line and a termination event of the borrowing capacity line.

17. The method of claim 16, further comprising:
identifying the termination event of the temporary borrowing capacity line; and
removing the temporary borrowing capacity line in response to the identifying.

18. The method of claim 16, further comprising:
detecting a posted refund corresponding to the expected refund; and
removing the temporary borrowing capacity line in response to the detecting.

19. The method of claim 16, wherein the evidence of the refund includes an email message or other documentation from a merchant.

20. The method of claim 16, wherein the notification is transmitted via a transceiver of the management service of the cloud server.
